(19) United States
(12) Patent Application Publication
(10) Pub. No.: US 2007/0204880 A1
(43) Pub. Date: Sep. 6, 2007

(54) METHOD OF WORKING SURFACES OF A COATING MADE OF HARD CARBON

(75) Inventors: Volker Weihnacht, Dresden (DE); Bernd Schultrich, Dresden (DE)

Correspondence Address: KAPLAN GILMAN GIBSON & DERNIER L.L.P., 900 ROUTE 9 NORTH, WOODBRIDGE, NJ, 07095, US

(73) Assignee: Fraunhofer-Gesellschaft zur Forderung der angewandten Forshung e.V., Munchen (DE)

(21) Appl. No.: 11/680,534

(22) Filed: Feb. 28, 2007

(30) Foreign Application Priority Data
Mar. 1, 2006 (DE) 10 2006 010 916.3

(51) Int. Cl. B08B 7/00; B05D 3/12

(52) U.S. Cl. 134/6; 427/355

(57) ABSTRACT

The invention relates to methods of working surfaces of a coating made of hard carbon such as —C or ta-C. In accordance with the object set, a smoothing of the surface of such a coating should be achieved with a low effort and low costs and a working of contoured surfaces should be achieved. In accordance with the invention, bristle-like or plate-like elements made of a metal and connected to a rotating element are brought into point-like or linear contact with the surface of the coating. These bristle-like or plate-like elements are moved along the surface and the surface is thus smoothed.

### BACKGROUND

The invention relates to a method of working surfaces of a coating made of hard carbon which is formed on substrates. Coatings of the most varied modifications of hard or diamond-like carbon can be worked so as to provide a surface of the coating with improved properties.

Coatings made of hard carbon can be formed on substrates using different technologies. The carbon layers can be made of crystalline diamond or amorphous carbon, with the latter also being able to contain alloy elements such as hydrogen, nitrogen, silicon or also metal elements.

In this connection, an irregular layer formation occurs more or less in the coatings, which results in voids, layer thickness fluctuations and also in a rough surface whose properties are not sufficient for a number of applications. A smoothing of surfaces of such coatings is thus frequently desired or also necessary to be able to use corresponding components for the respective purpose.

In particular coatings which are made with a modification of diamond-like carbon known as ta-C (tetrahedrally bonded amorphous carbon) having a very high hardness which can exceed 4,000 HV. Growth defects resulting in increased roughness usually occur. Such roughness peaks can only be avoided in the forming of such coatings by special technological modifications (e.g. particle filters). However, this in turn reduces the coating rate.

On the deposition of diamond layers, a surface structure influenced by the crystal facets normally occurs. The deposition of nanocrystalline, smooth layers is associated with a substantial reduction in the coating rate, which can make the manufacture unprofitable.

A number of methods have been developed for the working of surfaces of diamond coatings in addition to the classical mechanical polishing which can be divided into the following groups: thermomechanical polishing, chemomechanical polishing, plasma ion jet polishing and laser polishing. These methods are also suitable for the working of hard amorphous carbon layers.

The thermomechanical methods are based on a thermally activated decomposition reaction of the diamond. In a previously used possibility, molten iron or an iron alloy is thus contacted with the coating in an inert atmosphere and iron carbide is formed in this process which diffuses into the smelt. In addition to the obviously high effort, local roughness peaks can, however, thereby not be eliminated selectively, but there is rather a material removal over the total surface influenced in this manner. A similar solution, but one which does not use molten iron, but works at temperatures just below the melting temperature of iron, is described in U.S. Pat. No. 6,284,315.

A widespread technique is the working using rotating disks made of iron, nickel or molybdenum at high temperatures and pressures in an inert atmosphere (see also e.g. H. Tokura et al.; Thin Solid Films 212/1-2 (1992) p. 49-55). The effort and the required working time are here also high and only planar, non-contoured and non-curved surfaces can be worked.

Further working methods with the aid of plasma, an ion jet or a laser work in a non-contact manner and are also suitable for non-planar surfaces. They are, however, very complex and make vacuum conditions or controlled atmospheres necessary.

The solutions previously known for a desired working which smoothes the surface are complex and limited to planar surfaces or surfaces with limited curving or arching.

### SUMMARY OF THE INVENTION

It is therefore the object of the invention to propose possibilities for the working of surfaces on coatings made of hard carbon which result in a smoothing, which reduce the effort and the costs and which can also be used in contoured surfaces.

In accordance with the invention, this object is solved using a method of working surfaces of a coating made of a hard carbon on substrates, comprising: bringing bristle-like or plate-like elements made of a metal and connected to a rotating element into point-like or linear contact with the surface of the coating; and simultaneously rotating the bristle-like or plate-like elements and moving them on the surface to obtain a worked surface that is smoothed.

Advantageous aspects and further developments of the invention can be achieved using features designated in the subordinate claims.

In accordance with one or more aspects of the invention, the working takes place mechanically using a rotating element on which bristle-like or plate-like elements made of a metal are present. On a rotation of the rotating element, the ends of the bristle-like or plate-like elements at the front surface move over the surface and are, in this process, located in point-like or linear contact with the surface and a smoothing of the correspondingly worked region is thus achieved.

In this process, the bristle-like or plate-like elements can be moved directly over the surface, which in particular refers to the speed and to the pressure force applied to the surface. Both can be directly selected individually or also together. In this connection, the consistency of the respective coating, the surface geometry and also the dimensioning of an apparatus for the working can be taken into account. The last named aspect substantially relates to the respective size of the worked surface.

The bristle-like or plate-like elements should be flexibly bendable. The should preferably be made from a metal having an affinity to carbon or from such a metal alloy. They are, for example, iron or steels, also with their alloys.

They can be combined with other metals, e.g. soft metals, which are transferred directly to the carbon surface.

The rotating elements usable in the invention can therefore be equipped with a plurality of bristles or plates, with the bristle-like or plate-like elements then being able to be aligned orthogonally to the axis of rotation. Plate-like elements should in this connection be aligned parallel to one another and should be arranged at a spacing from one another.

There is, however, also the possibility of providing bristle-like or plate-like elements with an alignment parallel to the axis of rotation or at any other angles thereto on a rotating element. Said elements then respectively move along a circular orbit over the surface of a surface to be worked. Plate-like elements should in this connection be aligned at angular spacings to one another which are as equal as possible and should be arranged at spacings to one another.

Bristle-like elements should be present at an offset arranged at a rotating element taking account of the direction of movement.

In the working, the movement of bristle-like or plate-like elements along the surface of the coating should take place at a speed of at least about 1 m/s.

It has surprisingly been found that a working leading to the success of the invention of surfaces of a coating of a material having a hardness substantially larger than a material of bristle-like or plate-like elements is possible. The hardness of the materials used for bristle-like or plate-like elements can be less than about 50% of the hardness of the carbon modification forming the coating. The hardness of steel is thus, for example, usually at approx. 700 HV.

A smoothing takes place with the invention with a reduction of the relative roughness depth almost independent of the starting state of the surface of the coating.

The time required for the working, also while taking account of the surface size worked in each case, can be reduced with respect to known solutions. Different surface geometries can be worked by a corresponding selection of a rotating element equipped with bristle-like or plate-like elements. Convex or also concave surfaces, surfaces with steps and, optionally, also surface regions having undercuts can thus be worked in accordance with the invention.

Due to the working in accordance with the invention, a locally limited heating in the contact region of bristle-like or plate-like elements, which accompanies it, acts such that not only roughness peaks are reduced, but also a planing effect becomes achievable. In the selective local heating, a graphitization can occur and a transporting away of graphitized material in the coating as well as the diffusion of carbon into the material of bristle-like or plate-like elements can result in the coating.

Roughness peaks are acted on with a correspondingly increased surface pressure on contact with bristle-like or plate-like elements and are thereby removed and eliminated very effectively as such.

After the roughness peaks have been substantially removed, a considerably larger surface is worked and then, if at all, a substantially reduced material removal of the coating takes place so that the layer is maintained to its largest extent in its starting thickness.

A material transfer into incompletely filled recesses of a coating can also be achieved by means of metal contained in bristle-like or plate-like elements.

A relative movement between the substrate and the rotating element can take place in the working.

### BRIEF DESCRIPTION OF THE DRAWINGS

The invention will be explained in more detail by way of example in the following. There are shown:

FIG. 1, two examples for rotating elements which can be used for a working in accordance with the invention; and

FIG. 2, a diagram of achievable roughness depths at different coating thicknesses of a substrate.

### DETAILED DESCRIPTION OF THE EMBODIMENTS

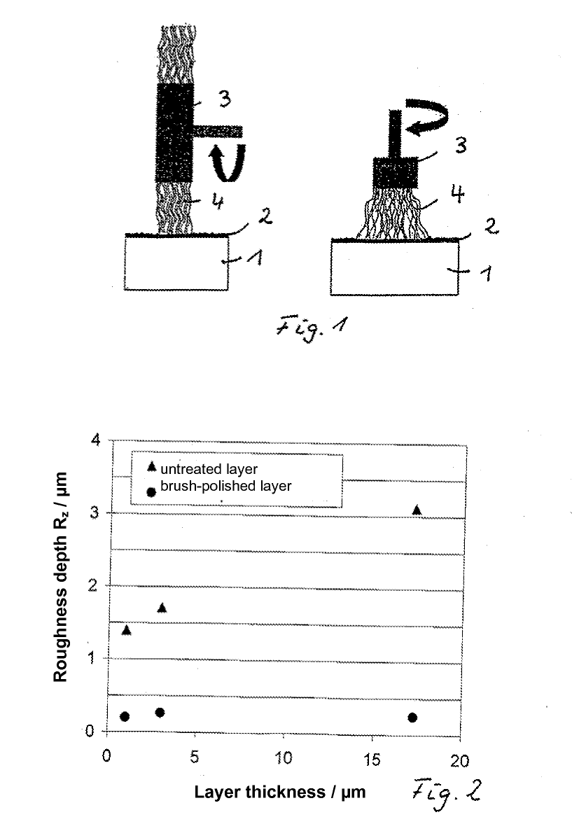

Two suitable, rotating elements 3, which are provided with a plurality of bristle-like elements 4, are illustrated by FIG. 1. The bristle-like elements 4 are made of thin steel wire in this example. They are aligned substantially orthogonally to the axis of rotation in the left hand representation and substantially parallel thereto in the right hand representation.

A rotating element 3 in accordance with the left hand representation of FIG. 1 was used with a width of 10 mm and a maximum outer diameter of 80 mm. The bristle-like elements 4 had a diameter of 0.3 mm. The rotation was carried out at a speed of 1000 r.p.m. so that a speed of 4 to 5 m/s was achieved.

A pressure force was exerted onto the surface via the bristle-like elements 4 of 10 N and a coating of ta-C was thus worked. The working of an area of 10 cm² in size could be ended with good success after approx. 1 min.

It can thus be seen from the diagram shown in FIG. 2 that the roughness depth was able to be considerably reduced in each case with a starting layer thickness of approx. 1 μm, 3 μm and 17 μm.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of working surfaces of a coating made of a hard carbon on substrates, comprising:
brining bristle-like or plate-like elements made of a metal and connected to a rotating element into point-like or linear contact with the surface of the coating; and
simultaneously rotating the bristle-like or plate-like elements and moving them on the surface to obtain a worked surface that is smoothed.

2. A method in accordance with claim 1, further comprising setting a pre-settable speed and/or pressure force at which the bristle-like or plate-like elements are moved over the surface to be worked and act on the surface.

3. A method in accordance with claim 1, wherein the bristle-like or plate-like elements are formed substantially from a metal or a metal alloy having an affinity to carbon.

4. A method in accordance with claim 1, wherein the bristle-like or plate-like elements are flexibly bendable.

5. A method in accordance with claim 1, wherein the bristle-like or plate-like elements are made of iron, a steel or an alloy thereof.

6. A method in accordance with claim 1, wherein the bristle-like or plate-like elements are made from a material having a hardness of less than about 50% of a hardness of the hard carbon forming the coating.

7. A method in accordance with claim 1, further comprising moving the bristle-like or plate-like elements along the surface of the coating at a speed of at least about 1 m/s.

8. A method in accordance with claim 1, wherein the coating is made of a-C, t-aC or diamond.

9. A method in accordance with further comprising making a material transfer into recesses in the coating such that it is not completely filled via the metal contained in the bristle-like or plate-like elements.
